(19) United States
(12) Patent Application Publication
(10) Pub. No.: US 2018/0338653 A1
(43) Pub. Date: Nov. 29, 2018

(54) Folding Support Stand Assembly

(71) Applicant: Maria Harris, Wikesboro, NC (US)

(72) Inventor: Maria Harris, Wikesboro, NC (US)

(21) Appl. No.: 15/604,324

(22) Filed: May 24, 2017

(51) Int. Cl. A47L 4/04; F16M 11/32

(52) U.S. Cl. CPC A47L 4/04; F16M 11/32

(57) ABSTRACT

A folding support stand assembly for cleaning window blinds includes a plate. A pair of first legs is coupled to and extends substantially coplanarly from a first edge of the plate. A pair of second legs is pivotally coupled to and extends from proximate to a second edge of the plate. The second legs are configured to selectively position in a stowed configuration and a deployed configuration. In the stowed configuration, the second legs are substantially parallel to the plate. In the deployed configuration, the second legs extend transversely from the plate. The first legs and the second legs position the plate in a leaning configuration relative to a surface. A plurality of couplers is coupled to a front face of the plate. The couplers are configured to reversibly couple to a window blind to couple the window blind to the plate. The window blind is positioned to be cleaned.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to stand assemblies and more particularly pertains to a new stand assembly for cleaning window blinds.

### BRIEF SUMMARY OF THE INVENTION

An embodiment of the disclosure meets the needs presented above by generally comprising a plate. A pair of first legs is coupled to and extends substantially coplanarly from a first edge of the plate. A pair of second legs is pivotally coupled to and extends from proximate to a second edge of the plate. The second legs are configured to selectively position in a stowed configuration and a deployed configuration. In the stowed configuration, the second legs are substantially parallel to the plate. In the deployed configuration, the second legs extend transversely from the plate. The first legs and the second legs position the plate in a leaning configuration relative to a surface. A plurality of couplers is coupled to a front face of the plate. The couplers are configured to reversibly couple to a window blind to couple the window blind to the plate. The window blind is positioned to be cleaned.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a folding support stand assembly according to an embodiment of the disclosure.

FIG. 2 is a side view of an embodiment of the disclosure.

FIG. 3 is a side view of an embodiment of the disclosure.

FIG. 4 is an in-use view of an embodiment of the disclosure.

FIG. 5 is a back view of an embodiment of the disclosure.

### DETAILED DESCRIPTION OF THE INVENTION

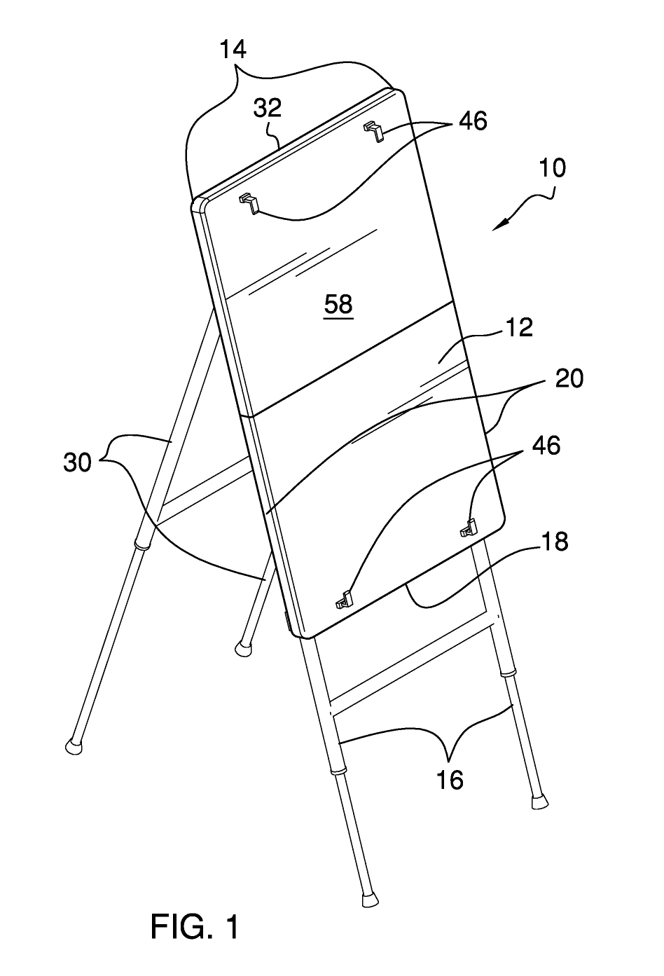

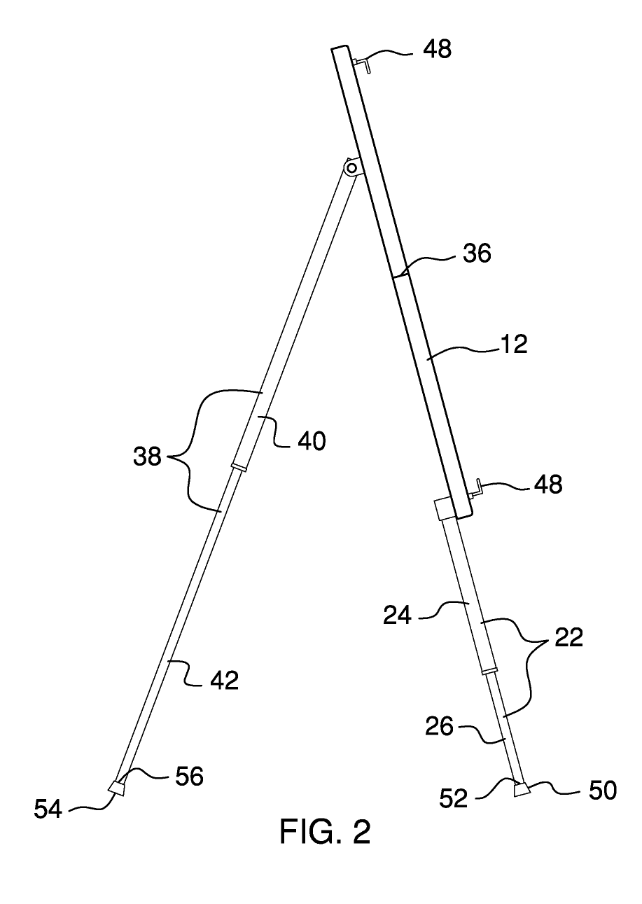

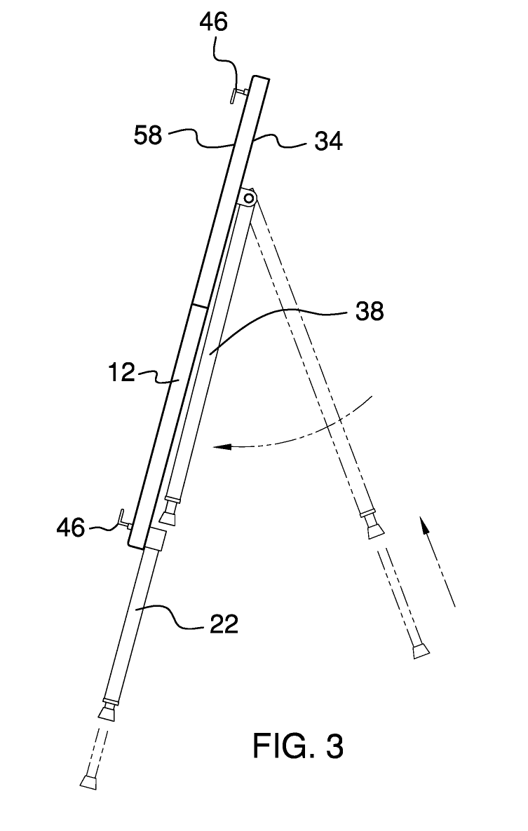

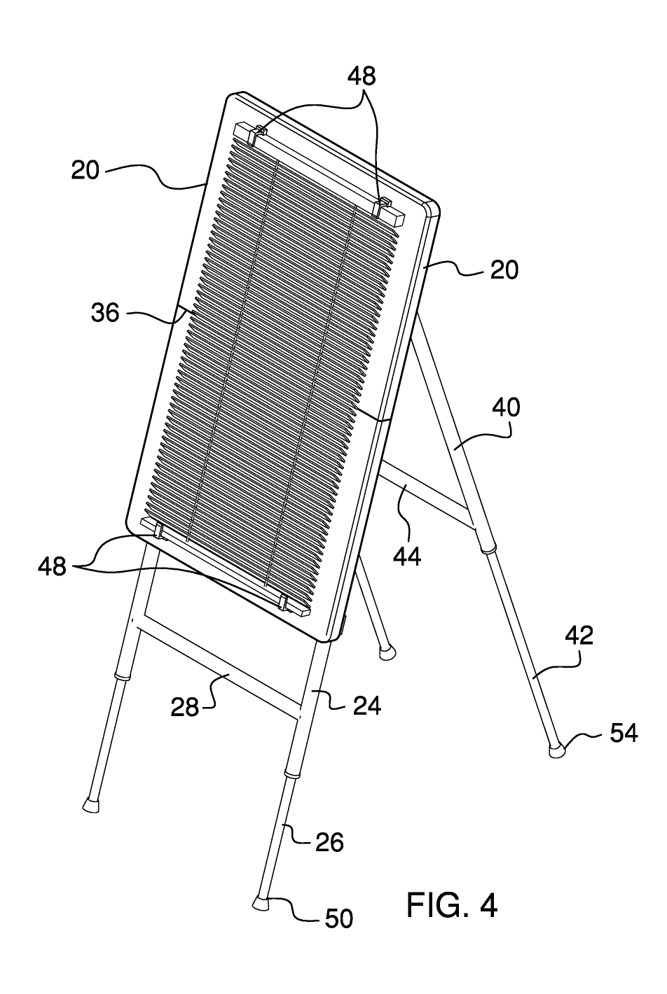

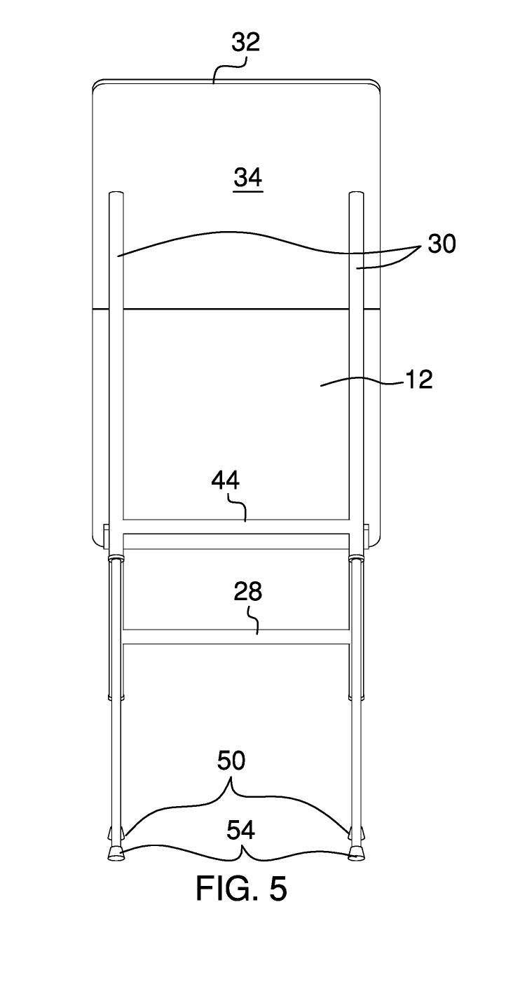

With reference now to the drawings, and in particular to FIGS. 1 through 5 thereof, a new stand assembly embodying the principles and concepts of an embodiment of the disclosure and generally designated by the reference numeral 10 will be described.

As best illustrated in FIGS. 1 through 5, the folding support stand assembly 10 generally comprises a plate 12. In one embodiment, the plate 12 is substantially rectangularly shaped. In another embodiment, the plate 12 is sized complementarily to a window blind when the window blind is fully extended. The plate 12 has corners 14. In yet another embodiment, the corners 14 are rounded.

A pair of first legs 16 is coupled to and extends substantially coplanarly from a first edge 18 of the plate 12. Each first leg 16 is positioned proximate to a respective opposing side edge 20 of the plate 12. In one embodiment, each first leg 16 comprises a plurality of first nested sections 22 so that the first leg 16 is selectively extensible. In another embodiment, the plurality of first sections 22 comprises an upper first segment 24 and a lower first segment 26. In yet another embodiment, the first legs 16 are substantially circularly shaped when viewed longitudinally.

A first crossbeam 28 is coupled to and extends between the pair of first legs 16. The first crossbeam 28 is positioned to stabilize the first legs 16 relative to the plate 12. In one embodiment, the first crossbeam 28 is coupled to the upper first segments 24 substantially equally distant from the plate 12 and the lower first segments 26. In another embodiment, the first crossbeam 28 is substantially circularly shaped when viewed longitudinally.

A pair of second legs 30 is pivotally coupled to and extends from proximate to a second edge 32 of the plate 12. The second legs 30 are configured to selectively position in a stowed configuration and a deployed configuration. In the stowed configuration, the second legs 30 are substantially parallel to the plate 12. In the deployed configuration, the second legs 30 extend transversely from the plate 12. The first legs 16 and the second legs 30 position the plate 12 in a leaning configuration relative to a surface upon which the first legs 16 and the second legs 30 are positioned.

In one embodiment, the second leg 30 are positioned a back face 34 of the plate 12 substantially equally distant from the second edge 32 and a midline 36 of the plate 12, and proximate to a respective opposing side edge 20 of the plate 12. In another embodiment, each second leg 30 comprises a plurality of second nested sections 38 so that the second leg 30 is selectively extensible. In yet another embodiment, the plurality of second nested section 38 comprises an upper second segment 40 and a lower second segment 42. In still yet another embodiment, the second legs 30 are substantially circularly shaped when viewed longitudinally.

A second crossbeam 44 is coupled to and extends between the pair of second legs 30. The second crossbeam 44 is positioned to stabilize the second legs 30 relative to the plate 12. In one embodiment, the second crossbeam 44 is coupled to the upper second segments 40 proximate to the lower second segments 42. In another embodiment, the second crossbeam 44 is substantially circularly shaped when viewed longitudinally.

A plurality of couplers 46 is coupled to a front face 58 of the plate 12. The couplers 46 are configured to reversibly couple to a window blind. The couplers 46 are configured to couple to the window blind to couple the window blind to the plate 12. The window blind is positioned to be cleaned.

In one embodiment, the plurality of couplers 46 comprises four couplers 46 that are positioned two apiece proximate to the first edge 18 and proximate to the second edge 32 of the plate 12. Each coupler 46 is positioned proximate to a respective corner 14 of the plate 12. In another embodiment, each coupler 46 comprises a clip 48. The clips 48 are complementary to an upper rail and a lower rail of the window blind. The clips 48 are configured to couple to the upper rail and the lower rail of the window blind to couple the window blind to the plate 12.

Each of a pair of first feet 50 is coupled to a bottom end 52 of a respective first leg 16. The first feet 50 are configured to position between the first legs 16 and the surface. Each of a pair of second feet 54 is coupled to a lower end 56 of a respective second leg 30. The second feet 54 are configured to position between the second legs 30 and the surface.

In use, the second legs 30 are configured to selectively position in the stowed configuration and the deployed configuration. In the stowed configuration, the second legs 30 are substantially parallel to the plate 12. In the deployed configuration, the second legs 30 extend transversely from the plate 12. The first legs 16 and the second legs 30 position the plate 12 in the leaning configuration relative to the surface upon which the first legs 16 and the second legs 30 are positioned. The clips 48 that are positioned on the plate 12 are configured to couple to the upper rail and the lower rail of the window blind to couple the window blind to the plate 12. The window blind is positioned to be cleaned.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A folding support stand assembly comprising:
a plate;
a pair of first legs coupled to and extending substantially coplanarly from a first edge of said plate;
a pair of second legs pivotally coupled to and extending from proximate to a second edge of said plate;
a plurality of couplers coupled to a front face of said plate, said couplers being configured for reversibly coupling to a window blind; and
wherein said second legs are positioned on said plate such that said second legs are configured for selectively positioning in a stowed configuration, wherein said second legs are substantially parallel to said plate, and a deployed configuration, wherein said second legs extend transversely from said plate and wherein said first legs and said second legs position said plate in a leaning configuration relative to a surface upon which said first legs and said second legs are positioned, wherein said couplers are positioned on said plate such that said couplers are configured for coupling to the window blind for coupling the window blind to said plate such that the window blind is positioned for cleaning.

2. The assembly of claim 1, further including said plate being substantially rectangularly shaped.

3. The assembly of claim 1, further including said plate being sized complementarily to a window blind when the window blind is fully extended.

4. The assembly of claim 1, further including said plate having corners, said corners being rounded.

5. The assembly of claim 1, further including each said first leg being positioned proximate to a respective opposing side edge of said plate.

6. The assembly of claim 1, further including each said first leg comprising a plurality of first nested sections such that said first leg is selectively extensible.

7. The assembly of claim 6, further including said plurality of first sections comprising an upper first segment and a lower first segment.

8. The assembly of claim 1, further including said first legs and said second legs being substantially circularly shaped when viewed longitudinally.

9. The assembly of claim 7, further including a first crossbeam, said first crossbeam being coupled to and extending between said pair of first legs, wherein said first crossbeam is positioned on said first legs such that said first crossbeam is positioned for stabilizing said first legs relative to said plate.

10. The assembly of claim 9, further including said first crossbeam being coupled to said upper first segments substantially equally distant from said plate and said lower first segments, said first crossbeam being substantially circularly shaped when viewed longitudinally.

11. The assembly of claim 1, further including each said second leg being positioned a back face of said plate substantially equally distant from said second edge and a midline of said plate and proximate to a respective opposing side edge of said plate.

12. The assembly of claim 1, further including each said second leg comprising a plurality of second nested sections such that said second leg is selectively extensible.

13. The assembly of claim 12, further including said plurality of second nested section comprising an upper second segment and a lower second segment.

14. The assembly of claim 13, further including a second crossbeam, said second crossbeam being coupled to and extending between said pair of second legs, wherein said second crossbeam is positioned on said second legs such that said second crossbeam is positioned for stabilizing said second legs relative to said plate.

15. The assembly of claim 14, further including said second crossbeam being coupled to said upper second segments proximate to said lower second segments, said second crossbeam being substantially circularly shaped when viewed longitudinally.

16. The assembly of claim 1, further including said plurality of couplers comprising four said couplers positioned two apiece proximate to said first edge and proximate to said second edge of said plate, each said coupler being positioned proximate to a respective corner of said plate.

17. The assembly of claim 1, further including each said coupler comprising a clip, said clips being complementary to an upper rail and a lower rail of the window blind, wherein said clips are positioned on said plate such that said clips are configured for coupling to the upper rail and the lower rail of the window blind for coupling the window blind to said plate.

18. The assembly of claim 1, further comprising:
a pair of first feet, each said first foot being coupled to a bottom end of a respective said first leg, wherein said first feet are positioned on said first legs such that said first feet are configured for positioning between said first legs and the surface; and
a pair of second feet, each said second foot being coupled to a lower end of a respective said second leg, wherein said second feet are positioned on said second legs such that said second feet are configured for positioning between said second legs and the surface.

19. A folding support stand assembly comprising:
a plate, said plate being substantially rectangularly shaped, said plate being sized complementarily to a window blind when the window blind is fully extended, said plate having corners, said corners being rounded;
a pair of first legs coupled to and extending substantially coplanarly from a first edge of said plate, each said first leg being positioned proximate to a respective opposing side edge of said plate, each said first leg comprising a plurality of first nested sections such that said first leg is selectively extensible, said plurality of first sections comprising an upper first segment and a lower first segment, said first legs being substantially circularly shaped when viewed longitudinally;
a first crossbeam, said first crossbeam being coupled to and extending between said pair of first legs, wherein said first crossbeam is positioned on said first legs such that said first crossbeam is positioned for stabilizing said first legs relative to said plate, said first crossbeam being coupled to said upper first segments substantially equally distant from said plate and said lower first segments, said first crossbeam being substantially circularly shaped when viewed longitudinally;
a pair of second legs pivotally coupled to and extending from proximate to a second edge of said plate, wherein said second legs are positioned on said plate such that said second legs are configured for selectively positioning in a stowed configuration, wherein said second legs are substantially parallel to said plate, and a deployed configuration, wherein said second legs extend transversely from said plate and wherein said first legs and said second legs position said plate in a leaning configuration relative to a surface upon which said first legs and said second legs are positioned, each said second leg being positioned a back face of said plate substantially equally distant from said second edge and a midline of said plate and proximate to a respective said opposing side edge of said plate, each said second leg comprising a plurality of second nested sections such that said second leg is selectively extensible, said plurality of second nested section comprising an upper second segment and a lower second segment, said second legs being substantially circularly shaped when viewed longitudinally;
a second crossbeam, said second crossbeam being coupled to and extending between said pair of second legs, wherein said second crossbeam is positioned on said second legs such that said second crossbeam is positioned for stabilizing said second legs relative to said plate, said second crossbeam being coupled to said upper second segments proximate to said lower second segments, said second crossbeam being substantially circularly shaped when viewed longitudinally;
a plurality of couplers coupled to a front face of said plate, said couplers being configured for reversibly coupling to a window blind, wherein said couplers are positioned on said plate such that said couplers are configured for coupling to the window blind for coupling the window blind to said plate such that the window blind is positioned for cleaning, said plurality of couplers comprising four said couplers positioned two apiece proximate to said first edge and proximate to said second edge of said plate, each said coupler being positioned proximate to a respective said corner of said plate, each said coupler comprising a clip, said clips being complementary to an upper rail and a lower rail of the window blind, wherein said clips are positioned on said plate such that said clips are configured for coupling to the upper rail and the lower rail of the window blind for coupling the window blind to said plate;
a pair of first feet, each said first foot being coupled to a bottom end of a respective said first leg, wherein said first feet are positioned on said first legs such that said first feet are configured for positioning between said first legs and the surface;
a pair of second feet, each said second foot being coupled to a lower end of a respective said second leg, wherein said second feet are positioned on said second legs such that said second feet are configured for positioning between said second legs and the surface; and
wherein said second legs are positioned on said plate such that said second legs are configured for selectively positioning in the stowed configuration, wherein said second legs are substantially parallel to said plate, and the deployed configuration, wherein said second legs extend transversely from said plate and wherein said first legs and said second legs position said plate in the leaning configuration relative to the surface upon which said first legs and said second legs are positioned, wherein said clips are positioned on said plate such that said clips are configured for coupling to the upper rail and the lower rail of the window blind for coupling the window blind to said plate such that the window blind is positioned for cleaning.
